(19) United States
(12) Patent Application Publication
(10) Pub. No.: US 2005/0044403 A1
(43) Pub. Date: Feb. 24, 2005

(54) Detection circuit for a smart card

(75) Inventor: Jung-Hyun Kim, Seoul (KR)

Correspondence Address: F. CHAU & ASSOCIATES, LLC, 130 WOODBURY ROAD, WOODBURY, NY, 11797, US

(73) Assignee: SAMSUNG ELECTRONICS CO., LTD.

(21) Appl. No.: 10/896,403

(22) Filed: Jul. 22, 2004

(30) Foreign Application Priority Data
Jul. 22, 2003 (KR) 2003-50122

(51) Int. Cl. H04L 9/00

(52) U.S. Cl. 713/200

(57) ABSTRACT

A detection circuit to determine whether a tampering of a smart card has occurred. The smart card having shield layers and non-shield layers. A comparator compares the count of shield layers and non-shield layers to generate and output based on which a reset signal to protect the smart card can be generated if the smart card has been tampered.

### TECHNICAL FIELD

The present invention relates to semiconductor devices and more specifically to securing a smart card having a semiconductor memory.

### BACKGROUND

Advances in semiconductor device technology have led to the development of portable semiconductor devices for various applications. Such portable semiconductor devices have various forms, for example, a miniaturized semiconductor memory device, popularly known as a “smart card” or a chip card. A smart card can be carried by a person anywhere, and is typically used to store personal information that is used in various electronic applications requiring personal data for authentication and other purposes.

A chip card or a smart card (hereafter “smart card” and “chip card” are used interchangeably and mean the same) is typically made of plastic material and has embedded memory chips and circuits that can used by microprocessor applications to read and write data to the chip card. Since the chip card is generally used to store private information, it is necessary to provide security features in the chip card to prevent tampering (hereafter the terms “tampering” and “unauthorized access” have been used to mean the same kind of intrusive attempt to access information on the chip card) of the private information.

FIG. 1A is a block diagram showing the internal construction of a smart card. As shown in FIG. 1A, the smart card includes a CPU, memory EEPROM, ROM and RAM, an address and a data bus, a SIO and a detection circuit. The CPU controls all the operations of the smart card. The CPU can store and process data in the card memory. The detection circuit protects information stored in the smart card memory, and if a tampering occurs, then the detection circuit resets a logic circuit in the smart card.

To protect a chip card from being tampered, an active shield may be used. In other words, when a shield portion of the chip card is damaged or removed to gain an unauthorized access, a logic circuit of a chip card is reset, so that it is possible to protect the chip card from an unauthorized access.

FIG. 1B shows a detection circuit employing an active shield technique in a conventional chip card. Referring to FIG. 1B, a detection circuit of a chip card employing a conventional active shield has a pull-up resistance. One end of the pull-up resistance is connected to a power voltage V_{cc}, and the other end of the pull-up resistance is connected to the active shield layers. The active shield layers are connected to a ground.

Accordingly, before the active shield layers are removed or damaged, one end of the pull-up resistance that is connected to the active shield layers is connected to the ground. As a result, a detection circuit connected to the one end of the pull-up resistance becomes “logic low” state. However, if one end of the pull-up resistance is electrically isolated with the active shield layers depending on the active shield layers' removal or damage by unauthorized access, a detection circuit is transitioned to “logic high” state to detect tampering.

However, due to such simplicity of the structure, there are many disadvantages of a detection circuit employing a conventional active shield. Since the detection point is connected to a ground, it is possible to either gain unauthorized access or reverse engineer the system, after the active shield is removed. Hence, there is a need for a smart card system with security features that prevent unauthorized access to the information stored in the card memory.

### SUMMARY OF THE INVENTION

A detection circuit capable of preventing tampering of a chip card by detecting damages to a shield layer of the chip card is provided.

In accordance with at least one embodiment of the present invention, a detection circuit of a chip card with an active shielding function, which includes shield layers, is provided. A shield layer counter for counting the shield layers, a non-shield counter for counting non-shield layers, and a comparator for deciding whether the chip card has been accessed in an unauthorized manner by comparing a count value of the shield layers counter with a count value of the non-shield counter layers is provided.

In a preferred embodiment, a reset part for resetting the chip card is further included if a tampering is detected from an output of the comparator.

In a preferred embodiment, each of the shield layer counter and the non-shield counter includes multiple count logic modules connected from each other in series. The count logic modules of the shield layer counter are electrically connected through the shield layers to each other. The count logic modules of the non-shield counter are electrically connected through the non-shield layers to each other.

In a preferred embodiment, the count logic modules include n-pieces of flip-flop circuits including a first flip-flop circuit where a clock signal is applied. The flip-flop circuits are electrically connected to provide an output of a k^{th} flip-flop as an input clock to a (k+1)^{th} flip-flop (where, k=1˜n−1). In at least one embodiment, the shield layers are formed of metal lines on a surface layer of the chip card.

A detection circuit of a chip card with an active shielding function includes shield layers, a shield layer counter for counting the shield layers and non-shield layers, a non-shield counter for counting the non-shield layers, and a comparator for deciding whether the chip card security is compromised by comparing a count value of the shield layers counter with a count value of the non-shield counter layers.

In addition, a detection circuit of a chip card with an active shielding function includes shield layers, a shield layer counter for counting the shield layers, a count controller for receiving a part of an output count value of the shield layer counter and using an output as an input of the shield layer counter, a non-shield counter for counting non-shield layers and a comparator for comparing a count value of the shield layer counter and the count controller with a count value of the non-shield layer counter.

In a preferred embodiment, the shield layers are formed of metal lines on a surface of the chip card, and a reset part capable of resetting a chip card is included if a tampering is detected from an output value of the comparator.

In a preferred embodiment, the shield layer counter and the non-shield counter which includes shield layer counters and the non-shield counter includes multiple count logic modules connected to each other in a series. The count logic modules of the shield layer counter are electrically connected through the active shield layers to each other. The count logic modules of the non-shield counter are electrically connected through the non-active shield layers to each other.

In at least one embodiment, the count logic modules include n-pieces of flip-flop circuits including a first flip-flop circuit where an output clock signal of a clock generator is utilized, and the flip-flop circuits are electrically connected to provide an output of a k^{th} flip-flop as an input clock signal to a (k+1)^{th} flip-flop (where, k=1˜n−1).

### BRIEF DESCRIPTION OF THE DRAWINGS

Preferred embodiments of the invention are described with reference to the accompanying drawings, of which:

FIG. 1A is a block diagram showing a smart card;

FIG. 1B shows a detection circuit employing an active shield method of a conventional chip card;

FIG. 2 is a block diagram of the detection circuit of the smart card in accordance with an embodiment of the present invention;

FIG. 3A is a circuit diagram of a shield layer counter used in FIG. 2;

FIG. 3B is a circuit diagram of a non-shield counter used in FIG. 2;

FIG. 3C is a circuit diagram of a comparator used in FIG. 2;

FIG. 4 is a block diagram of the detection circuit of the smart card;

FIG. 5A is a circuit diagram of a shield layer counter used in FIG. 4;

FIG. 5B is a circuit diagram of a non-shield counter used in FIG. 4;

FIG. 5C is a circuit diagram of a count control part of FIG. 4; and

FIG. 5D is a circuit diagram of a comparator of FIG. 4.

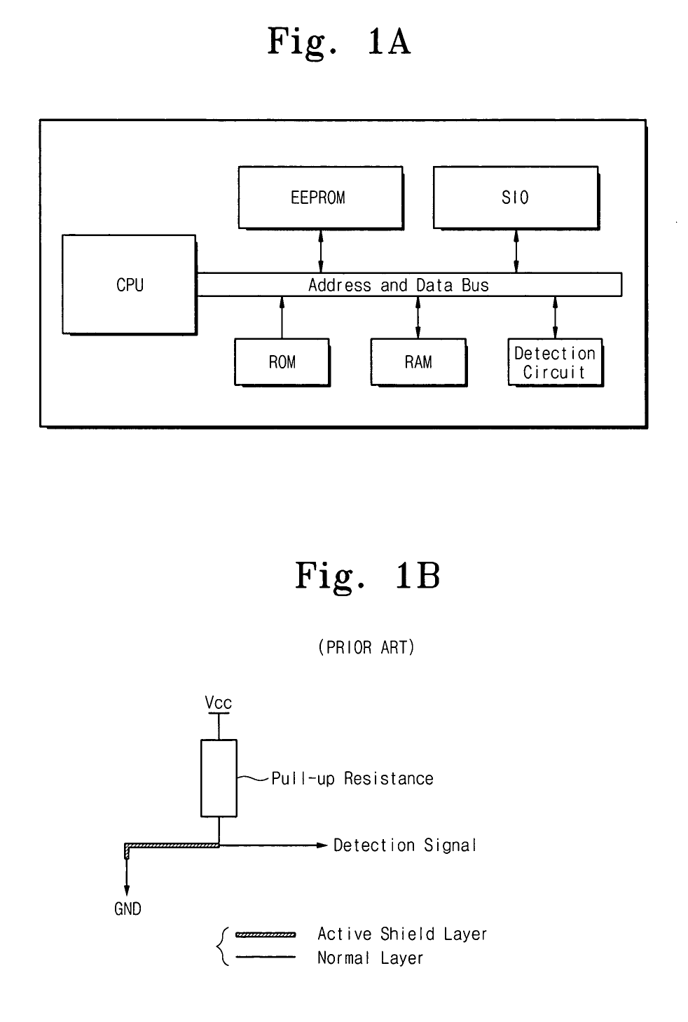

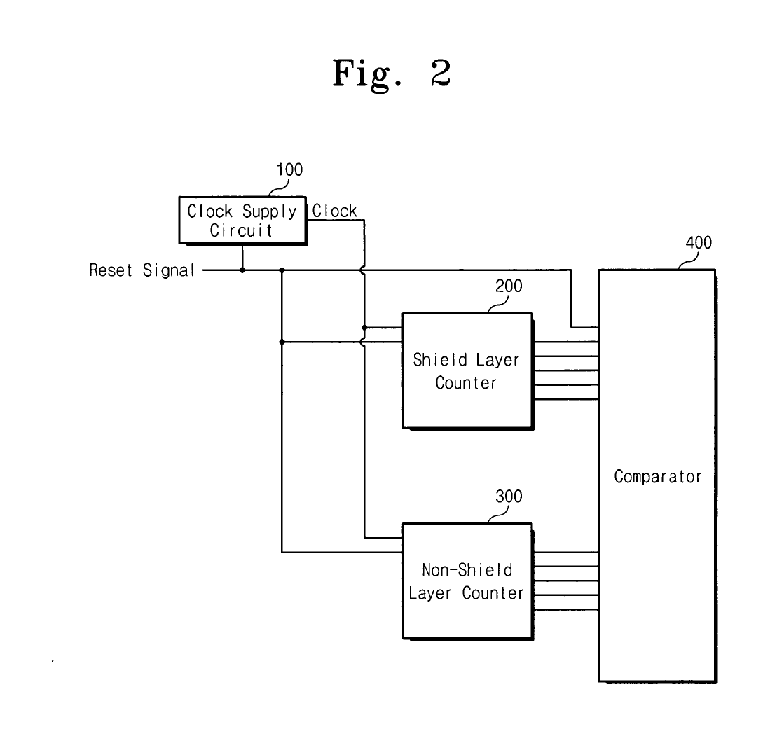

### DETAILED DESCRIPTION OF THE PREFERRED EMBODIMENTS

The preferred embodiments of the present invention will be described with reference to the appended drawings.

In the drawings, the thickness of layers and regions are exaggerated solely for the purposes of clarity and understanding. It will also be understood that when a layer is referred to as being “on” another layer, it can be directly on the other layer or intervening layers may also be present. Like numbers refer to like elements throughout the specification.

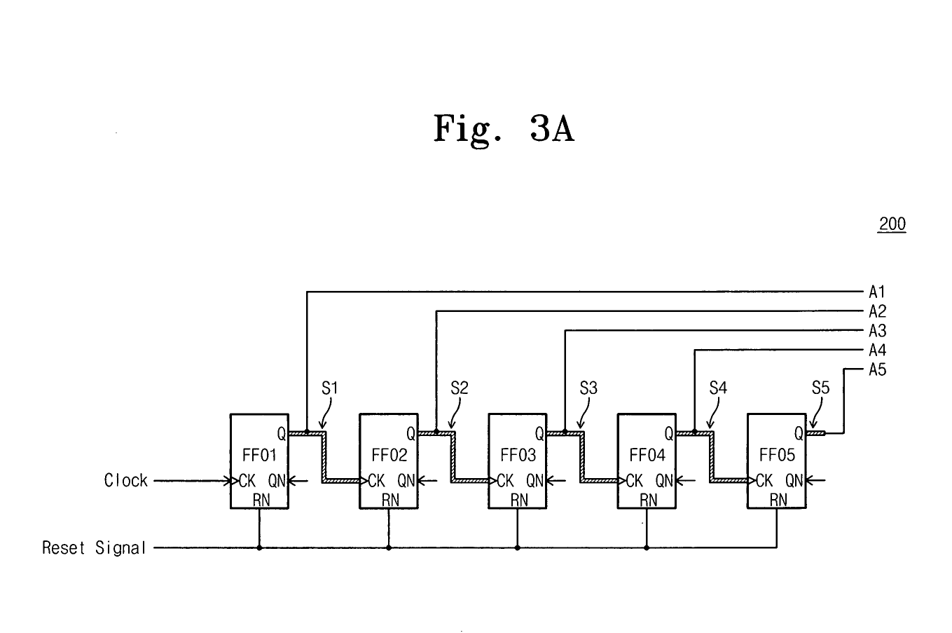

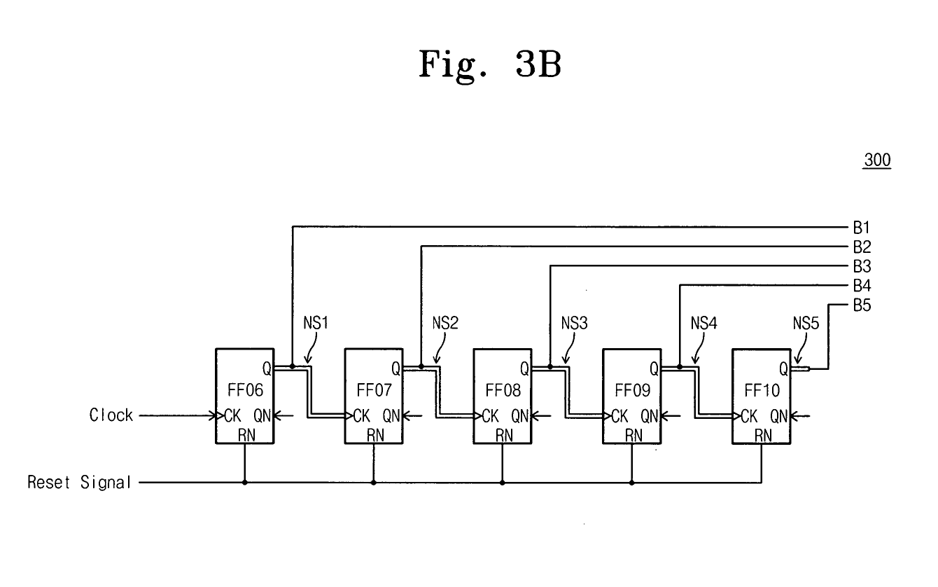

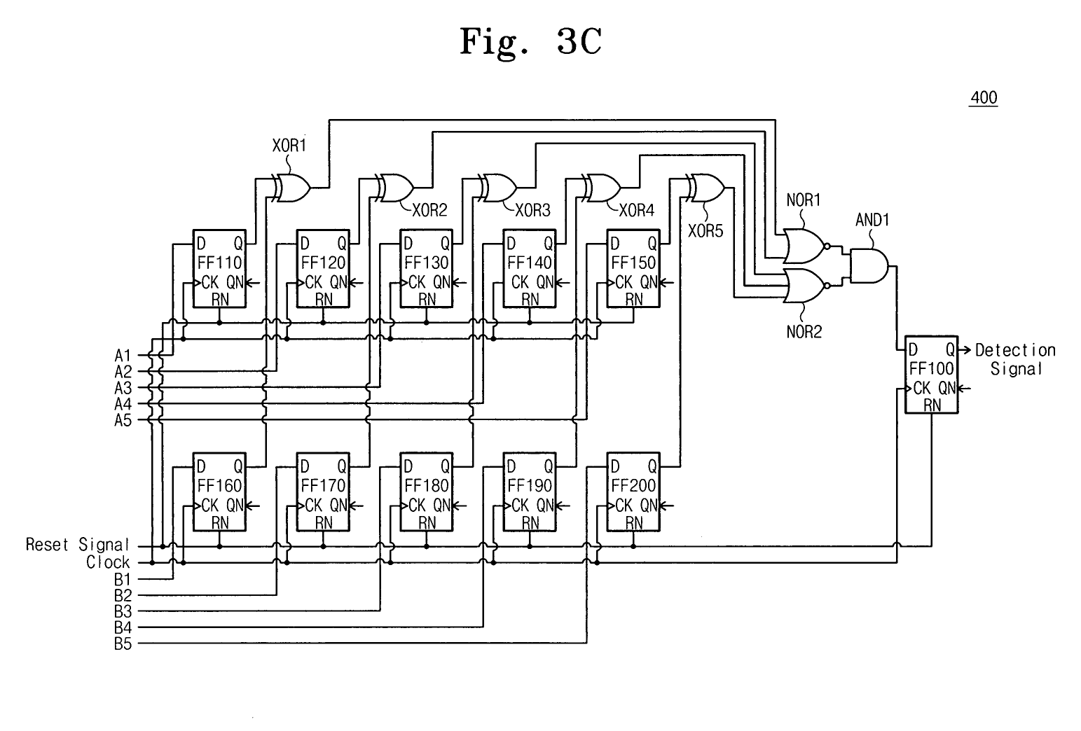

FIG. 2 is a block diagram of a detection circuit of a smart card. FIG. 3A is a circuit diagram of a shield layer counter used in FIG. 2. FIG. 3B is a circuit diagram of a non-shield counter used in FIG. 2. FIG. 3C is a circuit construction diagram of a comparator of FIG. 2.

Referring to FIG. 2, the detection circuit according to the first embodiment of the present invention includes a clock supply circuit 100; a shield layer counter 200 for counting and which is responsive to the transitions of a clock and a non-shield counter 300; and a comparator 400 for comparing a count value of the shield counter 200 and the non-shield counter 300 and generating a detection signal. In this case, the non-shields are equivalent to non-active shield layers.

Referring to FIG. 3A, the shield layer counter 200 has a multiplicity of flip-flop circuits FF01˜FF05. A reset signal is applied through each RN terminal to the flip-flop circuits FF01˜FF05. Each QN terminal is floated.

A clock signal Clock is applied as an input to the flip-flop circuit FF01. An output signal Q of the flip-flop circuit becomes an input clock signal to the flip-flop circuit FF02. An output Q of the flip-flop circuit FF02 becomes an input clock signal to the flip-flop circuit FF03. An output Q of the flip-flop circuit FF03 becomes an input clock signal to the flip-flop circuit FF04. An output Q of the flip-flop circuit FF04 becomes an input clock signal to the flip-flop circuit FF05.

Output count values A1˜A5 of the flip-flop circuits FF01˜FF05 are an input to the comparator 400 to be compared with output count values of the non-shield counter 300.

In this case, a connection line is a metal line for shield S1 of active shield layers. An output of the flip-flop circuit FF1 is connected through the connection line to an input clock of the flip-flop circuit FF2. The rest of the flip-flop circuits are connected through the metal lines S2˜S5 for the shield of the active shield layers.

As noted above, the flip-flop circuits are connected through an input and an output. Accordingly, if the metal line for shielding of the active shield layers is removed to have a tampering to a chip of the smart card, the removed metal line cuts an output of the flip-flop circuit and counting for the subsequent flip-flop circuits is stopped.

Referring to FIG. 3B, similar to the shield layer counter 200, a non-shield counter 300 has a multiplicity of flip-flop circuits FF06˜FF10. The flip-flop circuits FF06˜FF10 has a RN terminal where a reset signal is applied. The QN terminals are floated.

Count output values B1˜B5 of the flip-flop circuits serve as inputs to the comparator 400 to be compared with output count values Al˜A5 of the shield layer counters Al˜A5.

However, unlike the shield layer counter part 200, connecting portions between the flip-flop circuits are not completed through metal lines for the shields of active shield layers, but through metal lines NS1˜NS5 of non-shield layers in the non-shield counter 300.

The comparator 400 receives an output of the shield layer counter 200 and the non-shield counter 300 to compare a count value of the shield layer counter 200 with a count value the non-shield counter 300. In addition, the comparator 400 decides whether active shield layers are removed or not by employing the above result to output a detection signal.

Referring to FIG. 3C, the comparator 400 includes multiple flip-flop circuits FF110˜FF150 receiving one of the count values of the shield layer counter 200, multiple flip-flop circuits FF160˜FF200 receiving one of count values of the non-shield counter 300, an exclusive OR gate XOR1 receiving an output of the flip-flop circuit FF160, an exclusive OR gate XOR2 receiving an output of the flip-flop circuits FF120 and FF170, an exclusive OR gate XOR3 receiving an output of the flip-flop circuits FF130 and FF180, an exclusive OR gate XOR4 receiving an output of the flip-flop circuits FF140 and FF190, an exclusive OR gate XOR5 receiving an output of the flip-flop circuits FF150 and FF200, a NOR gate NOR1 receiving an output of the exclusive OR gates XOR1 and XOR2, a NOR gate NOR2 receiving an output of the exclusive OR gates XOR3, XOR4 and XOR5, an AND gate receiving the NOR gates NOR1 and NOR2 and a flip-flop circuit FF100 receiving an output of the AND gate.

As shown in FIG. 3C, the comparator 400 compares the following: an output count A1 of the shield layer counter 200 and an output count B1 of the non-shield counter 300, an output count A2 of the shield layer counter 200 and an output count B2 of the non-shield counter 300, an output count A3 of the shield layer counter 200 and an output count B3 of the non-shield counter 300, an output count A4 of the shield layer counter 200 and an output count B4 of the non-shield counter 300, and an output count A5 of the shield layer counter 200 and an output count B5 of the non-shield counter 300.

The comparator 400 decides whether a chip card has been accessed in an unauthorized manner or not by the above comparison. Before the security of a chip card is compromised, the output counts A1 and B1, A2 and B2, A3 and B3, A4 and B4, and A5 and B5 have the same value. The reason for this is that the output counts A1 and B1, A2 and B2, A3 and B3, A4 and B4 and A5 and B5 are counted while receiving the same clock.

When any connection of metal lines S1˜S5 for the shields of the shield layer counter 200 is cut depending on damages of active shield layers of a chip card by tampering, next flip-flop circuits are not counted any further.

When an output of a flip-flop circuit, where the count of the shield layer counter 200 is stopped, is compared with a corresponding output count of a flip-flop circuit of a non-shield counter 300, the two signals have different values. At this time, a detection circuit decides whether a tampering of the chip card has been attempted or not by detecting the different values. In other words, if the output count values are the same value as a result of the comparison performed by the comparator 400, the shield layers are regarded as not damaged. Hence, a signal informing authorized access is outputted. On the contrary, if the output count values are different value, the shield layers are regarded as damaged, and a detection signal informing a tampering of the chip card or an unauthorized access is outputted.

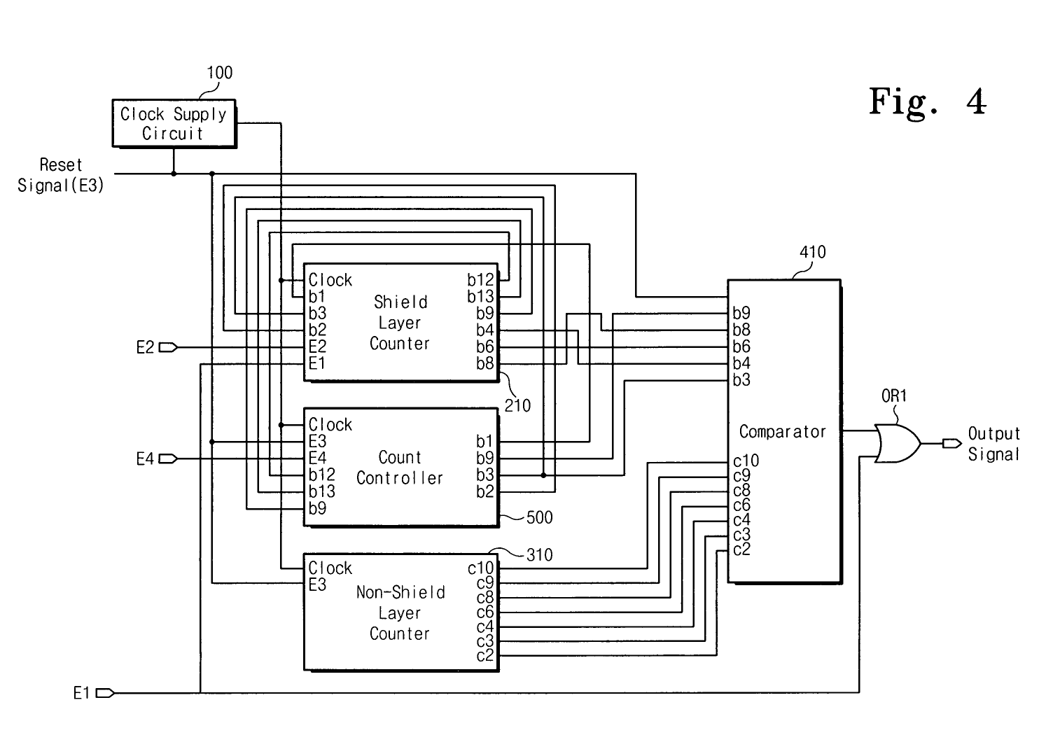

FIG. 4 is a block diagram of a detection circuit of a smart card.

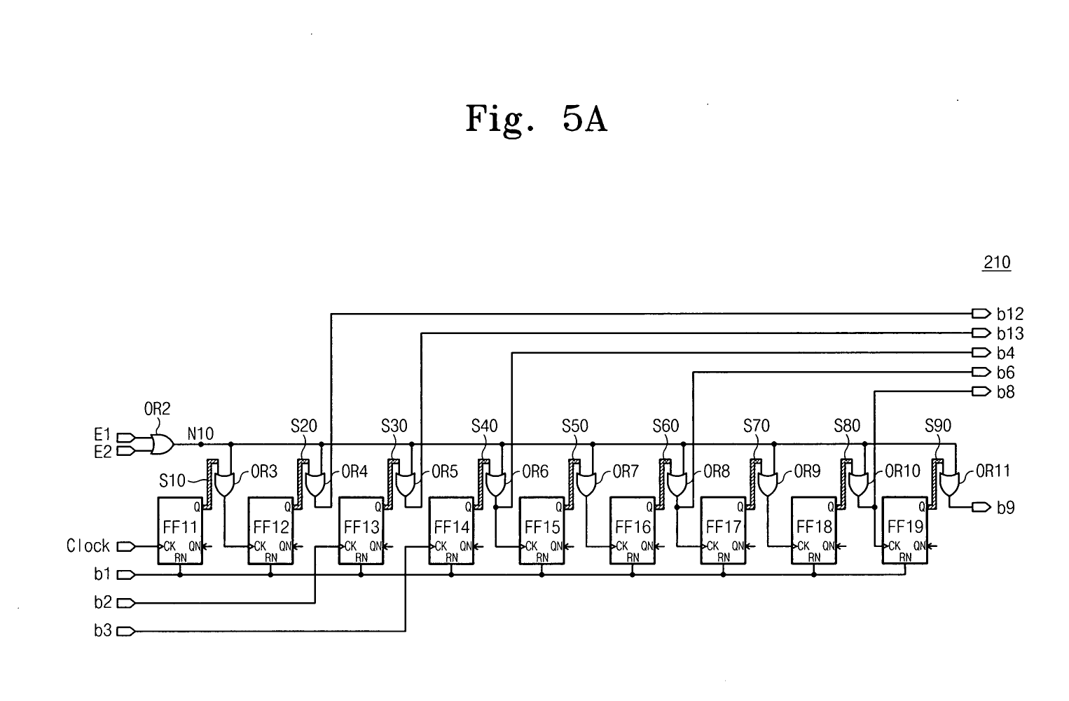

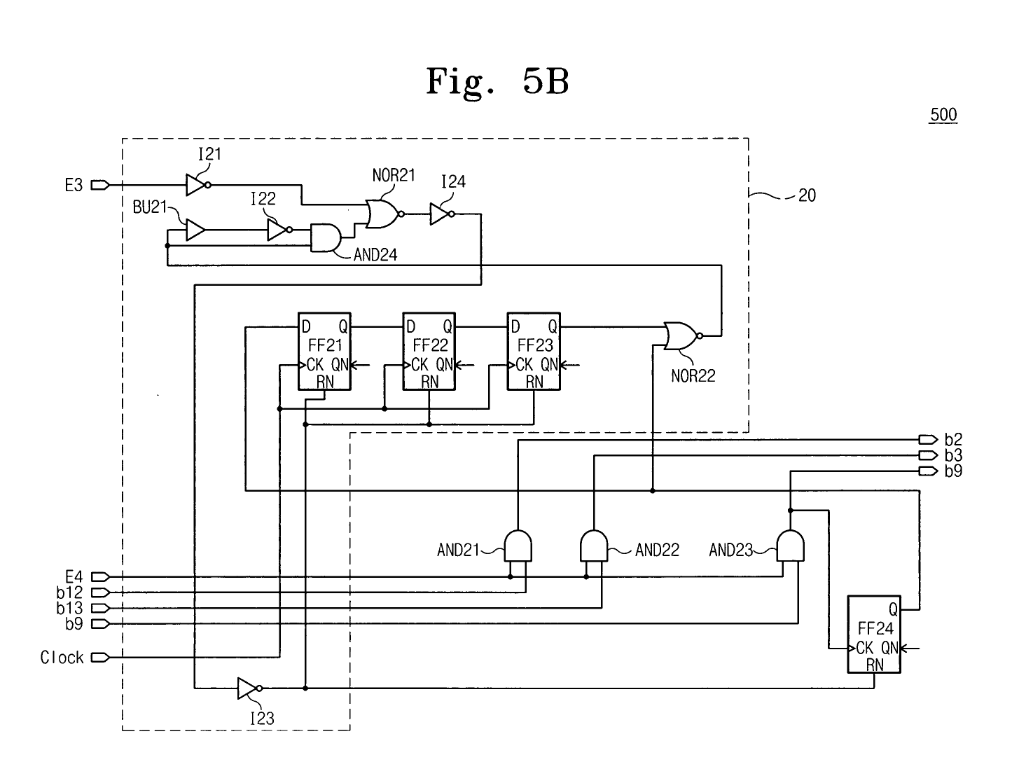

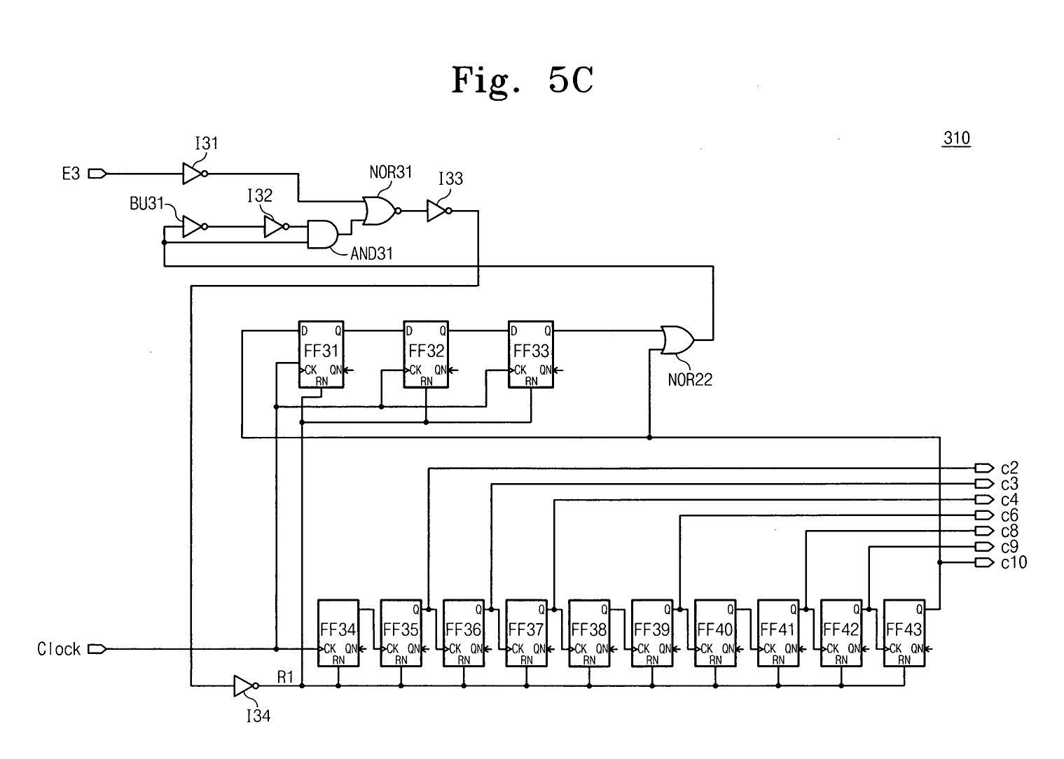

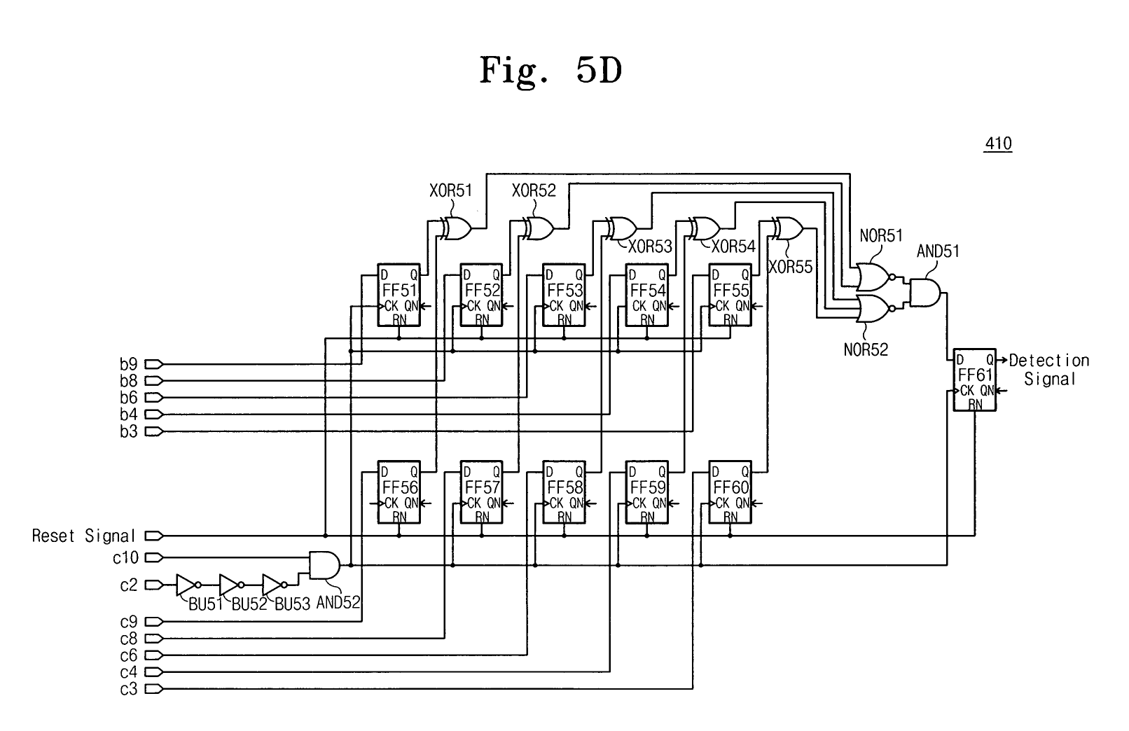

FIG. 5A is a circuit diagram of a shield layer counter of FIG. 4. FIG. 5B is a circuit diagram of a non-shield counter of FIG. 4. FIG. 5C is a circuit diagram of a counter controller of FIG. 4. FIG. 5D is a circuit diagram of FIG. 4.

Referring to FIG. 4, a detection circuit according to at least one embodiment includes a clock supply circuit 100 for generating a clock; a shield layer counter 210 receiving a clock signal to count and a non-shield counter 310; a count controller 500 receiving an output count value of the shield layer counter 210 and inputting an output to the shield layer counter 210; and a comparator 410 for comparing a count value of the shield layer counter 210 and the non-shield counter 310, and generating a detection signal.

In the detection circuit of the above described chip card (hereafter referred to as the “first chip card” only for the purpose of clarity and understanding), a shield layer counter 210 counts only shield layers. The non-shield counter 310 counts only non-shield layers. However, in the detection circuit of the second chip card, which is now being described, a part of a signal of the shield layer counter 210 becomes an input signal of the counter control part 500. The counter control part 500 is embodied in a non-shield layer. That is, a signal of a counter circuit for a detection circuit passes shield layers and non-shield layers.

Referring to FIG. 5A, the shield layer counter 210 has a multiplicity of flip-flop circuits FF11˜FF19, an OR gate OR2 receiving external signals El and E2; and OR gates OR3˜OR11 receiving outputs of the flip-flop circuits FF11˜FF19 and terminals N10 of the OR gate OR2. A reset signal b1 is applied through each RN terminal to the flip-flop circuits FF11˜FF19. Also, each QN terminal is floated. In this case, external signals E1 and E2 perform a function to generate abnormal count value.

A clock signal (Clock) is input to the flip-flop circuit FF11. An output signal Q of the flip-flop circuit FF11 is input to the OR gate OR3. An output of the OR gate OR3 becomes an input clock of the flip-flop circuit FF12.

Unlike the first chip card, in the detection circuit of the second chip card, all output signal of the flip-flop circuit are not applied to an input signal for the subsequent flip-flop circuit.

As shown in FIG. 5A, an output Q of the flip-flop circuit FF12 is applied to an OR gate OR4. An output of the OR gate OR4 is not applied to an input clock of the flip-flop circuit FF13 and is output to a b12 signal.

An output Q of the flip-flop circuit FF14 is applied to an OR gate OR6, and an output of the OR gate OR6 is applied to an input clock of the flip-flop circuit FF15. Also, an output of the OR gate OR6 becomes a comparison input signal B4 of the comparator 410.

An output of the OR gate OR6 is applied to the flip-flop circuit FF15. An output signal Q of the flip-flop circuit FF15 is applied to the OR gate OR7. An output of the OR gate OR3 becomes an input clock of the flip-flop circuit FF16.

An output Q of the flip-flop circuit FF16 is applied to an OR gate OR8, and an output of the OR gate OR8 is applied to an input clock of the flip-flop circuit FF17. An output of an OR gate OR8 becomes a comparison input signal b6 of the comparator 410.

An output of the OR gate OR8 is applied to the flip-flop circuit FF17. An output signal Q of the flip-flop circuit FF17 is applied to an OR gate OR9. An output of the OR gate OR9 becomes an input clock of the flip-flop circuit FF18.

An output Q of the flip-flop circuit FF18 is applied to an OR gate OR10, and an output of an OR gate OR10 is applied to an input clock of the flip-flop circuit FF19. An output of the OR gate OR10 becomes a comparison input signal b9 of the comparator 410.

In this case, a connection line is formed of a metal line for a shield S10. In the connection line, an output of the flip-flop circuit FF11 is applied to the OR gate OR3. Also, the rest of the flip-flop circuits are connected through metal lines S20˜S90 of active shield layers to the OR gates.

As noted above, the flip-flop circuits and OR gates are connected through an input and an output with each other. As a result, when any one of shield metal lines S10˜S90 for the shields of the active shield layers are damaged to have a tampering to the smart card, the count of a flip-flop circuit is cut by the removed metal line and a flip-flop circuit connected to the latter part of an OR gate is stopped.

Referring to FIG. 5B, a counter controller 500 includes an AND gate AND21 receiving an output signal b12 of an external input signal E4 and the shield layer counter 210 and outputting a comparison input signal b2; an AND gate AND22 receiving an external input signal E4 and an output signal b13 of the shield layer counter 210 and outputting a comparison input signal b3; an AND gate AND 23 receiving an external input signal E4 and an output b9 of the shield layer counter 210 and a comparison input signal b9; a flip-flop circuit FF24 using an output AND23 ad an input clock; and a reset circuit 20.

The reset circuit 20 includes a flip-flop circuit FF21 receiving an output of the flip-flop circuit FF24; a flip-flop circuit FF22 receiving an output of the flip-flop circuit FF21; a flip-flop circuit FF23 receiving an output of the flip-flop circuit FF22; a NOR gate NOR22 receiving an output of the flip-flop circuit FF23 and the flip-flop circuit FF24; a buffer BU21 receiving an output of the NOR gate NOR22; an inverter I22 connected to an output terminal of the buffer BU21; an AND gate AND 24 receiving output of the inverter I22 and the NOR gate NOR22; an inverter I21 receiving a reset signal E3; a NOR gate NOR21 receiving an output of the inverter I21 and the AND gate AND24; an inverter I24 receiving an output of the NOR gate NOR21; and an inverter I23 receiving an output of the inverter I24. In this case, the output is connected to flip-flop circuits FF21, FF22, FF23 and FF24.

Referring to FIGS. 5A and 5B, the shield layer counter 210 and the count control 500 exchange an input and an output with each other. That is, the counter control 500 receives a part of an output of the shield layer counter 210, and the shield layer counter 210 receives an output of the counter controller 210.

Concretely, the output signals b9, b12 and b13 of the shield layer counter 210 are applied to the counter control 500. In addition, the output signals b2 and b3 of the counter control 500 are applied to an input clock of the flip-flop circuits FF13 and FF14 being a logic counter of the shield layer counter 210 respectively, and an output signal b1 is applied to a reset signal of flip-flop circuits FF11˜FF19.

To completely prevent tampering, there is a request for exchanging an input and an output of the shield layer counter part 210 and the counter control part 500. An input clock of the shield layer counter is input through non-shield layers and not the active shield layers. Therefore, the shield layers as well as non-shield layers should be removed to avoid the detection circuit, so that any tampering is made very difficult.

A comparator 410 receives an output of the shield layer counter 210, a counter controller 500 and compares count values of them. Employing this result, the comparator 410 decides whether active shield layers are removed or not and outputs a detection signal.

Referring to FIG. 5D, the comparator 410 includes a multiplicity of flip-flop circuits FF51˜FF55 receiving one of output count values b3, b4, b6, b8 and b9 of the shield layer counter part 210; a multiplicity of flip-flop circuits FF56˜FF60 receiving one of output count values c3, c4, c6, c8 and c9 of the non-shield layer counter 310; an exclusive OR gate XOR51; an exclusive OR gate XOR52 receiving an output of the flip-flop circuit FF52 and the flip-flop circuit FF57; an exclusive OR gate XOR53 receiving an output of the flip-flop circuit FF53 and the flip-flop circuit FF58; an exclusive OR gate XOR54 receiving an output of the flip-flop circuit FF54 and the flip-flop circuit FF59; an exclusive OR gate XOR55 receiving an output of the flip-flop circuit FF55 and the flip-flop circuit FF60; a NOR gate NOR51 receiving an output of the exclusive OR gates XOR51 and XOR52; a NOR gate NOR52 receiving an output of the exclusive OR gates XOR3, XOR4 and XOR5; an AND gate AND51 receiving an output of the OR gates OR1 and OR2; and a flip-flop circuit FF61 receiving an output of the AND gate.

The above detection circuit is operated as follows. The shield layer counter part 210 and the non-shield layer counter 310 counts by receiving a clock signal generated from the clock supply circuit 100. In addition, the shield layer counter 210 and the non-shield layer counter 310 starts counting simultaneously when a reset signal E3 is disabled by receiving a clock signal (Clock) from the clock supply circuit. If a count value is overflowed, a count becomes clear automatically. As a result, an operation of count is performed again. If an overflow occurs in the shield layer counter 210, a count value becomes clear by receiving a b1 signal generated from a count control 500, so that an operation of count is performed again by receiving a clock signal (Clock).

If an overflow occurs in the non-shield counter 310, a count value of the non-shield counter 310 becomes clear by receiving a R1 signal generated from the non-shield counter 310, so that an operation of count is performed again by receiving a clock signal (Clock).

Output count values of the shield layer counter and the non-shield counter are compared in a comparator 410. If active shield layers are removed to gain an unauthorized access, count values of the non-shield counter part 310 and the shield layer counter part 210 have different values. The count value of the shield layer counter 210 is connected to the active shield layers to be counted, and the value of the non-shield counter 310 is counted normally. Accordingly, the comparator 410 outputs a reverse signal of a normal signal as a detection signal. If the detection signal is output, a central processing unit (CPU) resets a chip card to protect information therein. Irrespective of active shield layers, E1 and E2 signals of the shield layer counter 210 performs a function to make abnormal count value. Even if any one of E1 and E2 signals is applied, an operation of count is performed abnormally, so that a detection signal being the same signal that is generated when a tampering is detected. If a b1 signal becomes inactive, a clock signal (Clock) performs a count operation.

A count controller 500 generates a b1 signal that performs a function of clearing by employing a clock signal (Clock) and sends the b1 signal to the shield layer counter 210, if a count value of the shield layer counter is overflowed. An E4 signal is provided to generate a signal for generating a condition by which a count value is disabled. In other words, the signal E4 disables the tampering detection circuit by the count value together with an input signal of a circuit, if it exists, which detects the light and then generates a tampering signal.

The E4 signal sends a different signal depending on chip card's operation to distinguish the shield layer counter 210 from the non-shield counter 310. As a result, it is possible to protect a chip card from tampering.

In the non-shield counter 310, when signal E3 becomes inactivated, an operation of count is performed. Then, if a count is overflowed, the count becomes clear automatically. Accordingly, an operation of the count is performed again.

The count of the non-shield layer counter 310 and the shield layer counter 210 becomes clear simultaneously, and then an operation of a count is performed again if E3 signal becomes inactivated. The non-shield counter 310 sends signals c2, c3, c4, c6, c8, c9 and c10 to the comparator 410. To remove a noise of output count values of the non-shield counter 310, the shield layer counter 210 and the count controller 500, the comparator 410 uses signals c10 and c2 as a latch clock.

The comparator latches b3, b4, b6, b8 and b9 count values of the shield layer counter 210 and the count control 500 and c3, c4, c6, c8 and c9 count values of the non-shield counter 310. Then, after the comparator compares the latched count values, it outputs a detection signal.

As previously mentioned, according to the present invention, a detection circuit employing active shield layers can have more complex structure, so that it is possible to protect a chip card from tampering.

Furthermore, the detection circuit can be formed to pass the active shield layers and the non-shield layers. Accordingly, a chip card can be completely protected from being tampered with.

While the present invention has been particularly shown and described with reference to exemplary embodiments thereof, it will be understood by those skilled in the art that various changes in form and details may be made therein without departing from the spirit and scope of the present invention as defined by the appended claims.

1. A detection circuit of a chip card with an active shielding function, the circuit comprising:
a plurality of shield layers;
a plurality of non-shield layers;
a shield layer counter for counting the shield layers;
a non-shield counter for counting the non-shield layers; and
a comparator for determining whether the chip card has been tampered by comparing a count value of the shield layers counter with a count value of the non-shield counter layers.

2. The detection circuit of claim 1, further comprising:
a reset part for resetting the chip card if a tampering is detected from an output of the comparator.

3. The detection circuit of claim 1, wherein each of the shield layer counter and the non-shield counter comprises a plurality of count logic modules connected from each other in series, wherein the count logic modules of the shield layer counter are electrically connected through the shield layers each other, and the count logic modules of the non-shield counter are electrically connected through the non-shield layers each other.

4. The detection circuit of claim 3, wherein the count logic modules comprisen-pieces of flip-flop circuits including a first flip-flop circuit where a clock signal is applied, wherein the flip-flop circuits are electrically connected to make an output of a k^{th} flip-flop an input clock of a (k+1)^{th} flip-flop (where, k=1˜n−1).

5. The detection circuit of claim 1, wherein the shield layers are formed of metal lines on a surface layer of the chip card.

6. A detection circuit of a chip card with an active shielding function, comprising:
a plurality of shield layers;
a shield layer counter for counting the shield layers and non-shield layers;
a non-shield counter for counting the non-shield layers; and
a comparator for determining whether the chip card has been tampered by comparing a count value of the shield layers counter with a count value of the non-shield counter layers.

7. The detection circuit of claim 6, wherein the shield layers are formed of metal lines on a surface of the chip card.

8. A detection circuit of a chip card with an active shielding function, comprising:
a plurality of shield layers and non-shield layers;
a shield layer counter for counting the shield layers;
a count controller for receiving a part of an output count value of the shield layer counter and using an output as an input of the shield layer counter;
a non-shield counter for counting non-shield layers; and
a comparator for comparing a count value of the shield layer counter and the count controller with a count value of the non-shield layer counter.

9. The detection circuit of claim 8, wherein the shield layers are formed of metal lines on a surface of the chip card.

10. The detection circuit of claim 6, further comprising a reset part capable of resetting the chip card if a tampering is detected from an output value of the comparator.

11. The detection circuit of claim 6, wherein each of the shield layer counter and the non-shield counter comprises a plurality of count logic modules connected with each other in a series, wherein the count logic modules of the shield layer counter are electrically connected through active shield layers with each other and the count logic modules of the non-shield counter are electrically connected through non-active shield layers with each other.

12. The detection circuit of claim 11, wherein the count logics comprises n-pieces of flip-flop circuits including a first flip-flop circuit where an output clock of a clock generator is applied, and the flip-flop circuits are electrically connected to make an output of a k^{th} flip-flop an input clock of a (k+1)^{th} flip-flop (where, k=1˜n−1).

13. The detection circuit of claim 8 wherein the count controller resetting the shield layer counter for an overflow condition of the shield layer counter.

14. The detection circuit of claim 8 wherein the non-shield counter resetting on an occurrence of an overflow condition for the non-shield counter.

15. A method for detecting a tampering in a smart card, the method comprising:
determining a plurality of shield layers;
determining a plurality of non-shield layers;
comparing the count of shield layers and non-shield layers using a comparator; and
determining a tampering of the smart-card from the output of the comparator.

16. The method of claim 14 further comprising:
resetting the chip card if a tampering is detected from an output of the comparator.
